(19) United States
(12) Patent Application Publication
(10) Pub. No.: US 2012/0301605 A1
(43) Pub. Date: Nov. 29, 2012

(54) GRAVURE PRINTING ENGRAVING ROLL AND MANUFACTURING METHOD THEROF

(75) Inventors: Tae Hyeong KIM, Suwon (KR); Gee Lyong KIM, Suwon (KR); Young Ha JUN, Seoul (KR); Gi Woo LEE, Suwon (KR); Ki Ho YEO, Siheung (KR); Jai Moo YOO, Ansan (KR)

(73) Assignee: SAMSUNG ELECTRO-MECHANICS CO., LTD.

(21) Appl. No.: 13/474,192

(22) Filed: May 17, 2012

(30) Foreign Application Priority Data
May 26, 2011 (KR) 10-2011-0050227

(51) Int. Cl. B05C 1/00; H01G 13/00; B05D 5/00

(52) U.S. Cl. 427/79; 118/200; 427/258

(57) ABSTRACT

There are provided a gravure printing engraving roll and a manufacturing method thereof. The gravure printing engraving roll includes: a base layer provided with gravure printing patterns; and a reinforcement coating layer applied to the base layer in order to reinforce strength of the base layer, the reinforcement coating layer including a first reinforcement layer formed on the base layer by a wet plating method, a second reinforcement layer forming an outer surface of the reinforcement coating layer, a first adhesive layer disposed between the first and second reinforcement layers and providing adhesive strength to a surface of the first reinforcement layer, and a second adhesive layer providing adhesive strength between the first adhesive layer and the second reinforcement layer.

### CROSS-REFERENCE TO RELATED APPLICATIONS

This application claims the priority of Korean Patent Application No. 10-2011-0050227 filed on May 26, 2011, in the Korean Intellectual Property Office, the disclosure of which is incorporated herein by reference.

### BACKGROUND OF THE INVENTION

1. Field of the Invention

The present invention relates to a gravure printing engraving roll and a manufacturing method thereof and, more particularly, to a gravure printing engraving roll having enhanced abrasion resistance and durability, and a manufacturing method thereof.

2. Description of the Related Art

Gravure printing refers to a method of forming an intaglio printing pattern on a surface of a cylindrical metal roll, injecting ink into the intaglio printing pattern, and transferring the pattern to a surface of a printing subject (an object or a target) in the form of continuous paper wound in the form of a roll. Gravure printing has a far faster speed and better printing quality than existing plate-type printing and it has been widely used in the fields of photography, packaging materials and textiles printing. Recently, on the strength of excellent productivity, gravure printing has been expanded to be applied to various fields covering the fields of the Information Technology (IT) industry, and the electronics industry field beyond existing fields of application.

As a gravure printing metal roll (copper plate roll) is continuously brought into contact with a metal blade for removing ink or paste, extra ink or extra paste, or a printing subject in the form of paper, generating friction therebetween. Damage to the shape of the metal roll due to the friction may cause various defects in printing.

Recently, gravure printing has been performed by using an ink or a paste containing a material performing an electric/electronic function such as ceramic or metal powder in the IT electronics industry field. However, metal, ceramic ink, or paste has an extremely high content of solid ingredients and extremely high abrasiveness, as compared with existing color development or coating gravure ink, so that when such a material is applied to gravure printing, it is very difficult to manage a lifespan and printing quality of a printing system.

Thus, in order to apply a metal/ceramic ink/paste system having high abrasiveness characteristics to gravure printing, it is very important to improve abrasion resistance (or wear resistance) of a gravure printing engraving roll which receives the majority of frictional energy of a gravure printing system.

### SUMMARY OF THE INVENTION

An aspect of the present invention provides a gravure printing engraving roll having improved hardness and abrasion resistance, and a method of manufacturing the same.

Another aspect of the present invention provides a multilayer ceramic capacitor manufactured by using the gravure printing engraving roll having improved hardness and abrasion resistance.

According to an aspect of the present invention, there is provided a gravure printing engraving roll including: a base layer provided with gravure printing patterns; and a reinforcement coating layer applied to the base layer in order to reinforce strength of the base layer, the reinforcement coating layer including a first reinforcement layer formed on the base layer by a wet plating method, a second reinforcement layer forming an outer surface of the reinforcement coating layer, a first adhesive layer disposed between the first and second reinforcement layers and providing adhesive strength to a surface of the first reinforcement layer, and a second adhesive layer providing adhesive strength between the first adhesive layer and the second reinforcement layer.

The first adhesive layer may allow the surface of the first reinforcement layer to be uniform.

A lattice constant of the second adhesive layer may have a value between a lattice constant of the first adhesive layer and a lattice constant of the second reinforcement layer.

The base layer may be a plated layer including copper (Cu).

The first reinforcement layer may be a wet plated layer including chromium (Cr).

The second reinforcement layer may be formed as a diamond like carbon (DLC) film.

The second reinforcement layer may be formed as a DLC film including silicon (Si).

An atomic fraction of silicon (Si) with respect to DLC of the second reinforcement layer may be 2% to 15%.

The first adhesive layer may be a metal layer including one or more selected from a group consisting of tungsten (W), titanium (Ti), chromium (Cr), zirconium (Zr), and molybdenum (Mo).

The second adhesive layer may be a metal nitride layer including one or more metal selected from a group consisting of tungsten (W), titanium (Ti), chromium (Cr), zirconium (Zr), and molybdenum (Mo).

The thickness of the first reinforcement layer may range from 0.1 μm to 10 μm.

The thickness of the second reinforcement layer may range from 0.2 μm to 2 μm.

The thickness of the first adhesive layer may range from 0.1 μm to 5 μm.

The thickness of the second adhesive layer may range from 0.1 μm to 1 μm.

The printing patterns may be internal electrode printing patterns for a multilayer ceramic capacitor (MLCC).

According to another aspect of the present invention, there is provided a method of manufacturing a gravure printing engraving roll, the method including: forming patterns for gravure printing on a base layer; forming a first reinforcement layer on the base layer by a wet plating method; forming a first adhesive layer providing adhesive strength to a surface of the first reinforcement layer on the first reinforcement layer; forming a second adhesive layer on the first adhesive layer so as to provide adhesive strength with the second reinforcement layer; and forming a second reinforcement layer on the second adhesive layer.

The first adhesive layer may allow the surface of the first reinforcement layer to be uniform.

A lattice constant of the second adhesive layer may have a value between a lattice constant of the first adhesive layer and a lattice constant of the second reinforcement layer.

The base layer may be formed through a copper (Cu) plating process.

The first reinforcement layer may be formed through a chromium (Cr) wet plating process.

The second reinforcement layer may be formed through a diamond like carbon (DLC) film deposition process.

The thickness of the first reinforcement layer may range from 0.1 μm to 10 μm.

The thickness of the second reinforcement layer may range from 0.2 μm to 2 μm.

The thickness of the first adhesive layer may range from 0.1 μm to 5 μm.

The thickness of the second adhesive layer may range from 0.1 μm to 1 μm.

According to another aspect of the present invention, there is provided a method of manufacturing a multilayer ceramic capacitor, the method including: preparing a plurality of dielectric layers; and printing internal electrode patterns on the plurality of dielectric layers by immersing the gravure printing engraving roll of claim 1 in paste for internal electrodes.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a schematic sectional view and a partially enlarged view of a gravure printing engraving roll according to an embodiment of the present invention;

FIG. 2 is a partially enlarged view of a reinforcement coating layer of the gravure printing engraving roll according to an embodiment of the present invention;

FIGS. 3A through 3C show a process flow chart illustrating a process of forming a printing pattern on the base layer 20 of the gravure printing engraving roll according to an embodiment of the present invention.

FIGS. 4A through 4D show a process flow chart illustrating a method of manufacturing a reinforcement coating layer of the gravure printing engraving roll according to an embodiment of the present invention;

FIG. 5 is a schematic view showing printing of internal electrodes of a multilayer ceramic capacitor (MLCC) by using the gravure printing engraving roll according to an embodiment of the present invention; and

FIGS. 6A and 6B are a perspective view and a partial sectional view of a gravure printing engraving roll for a multilayer ceramic capacitor according to an embodiment of the present invention.

### DETAILED DESCRIPTION OF THE INVENTION

Embodiments of the present invention will now be described in detail with reference to the accompanying drawings such that they could be easily practiced by those having skill in the art to which the present invention pertains. However, in describing the embodiments of the present invention, detailed descriptions of well-known functions or constructions will be omitted so as not to obscure the description of the present invention with unnecessary detail.

In addition, like reference numerals denote like elements throughout the drawings.

Unless explicitly described to the contrary, the word “comprise” and variations such as “comprises” or “comprising,” will be understood to imply the inclusion of stated elements but not the exclusion of other elements.

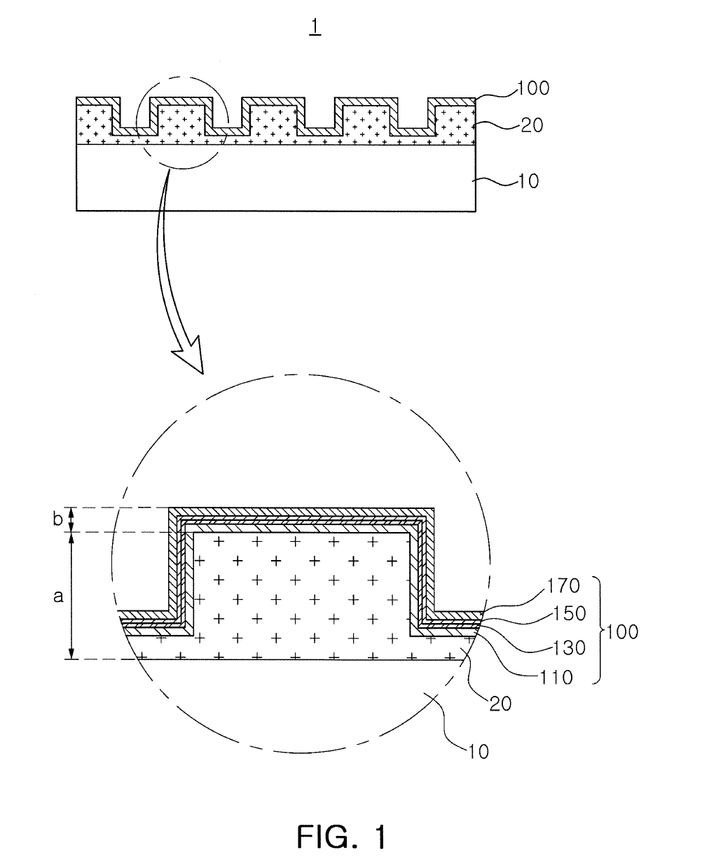

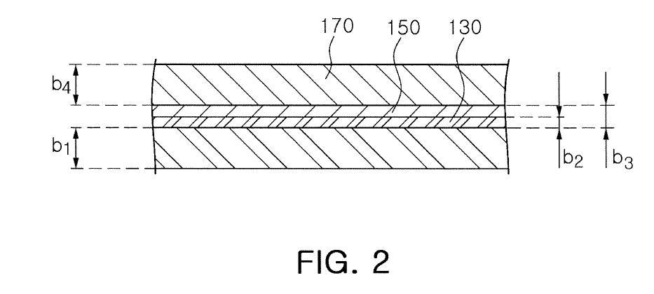

Hereinafter, a gravure printing engraving roll according to an embodiment of the present invention will be described in detail with reference to FIGS. 1 and 2.

FIG. 1 is a schematic sectional view and a partially enlarged view of a gravure printing engraving roll 1 according to an embodiment of the present invention.

Referring to FIG. 1, a gravure printing engraving roll 1 according to an embodiment of the present invention includes a base layer 20 with a printing pattern formed thereon, and a reinforcement coating layer 100 applied to the base layer 20 in order to reinforce the strength of the base layer 20.

A printing pattern desired to be printed is formed on the base layer 20. The gravure printing engraving roll 1 is immersed in ink or paste such that a printing material (or a printing medium) is filled in the printing pattern, and then the gravure printing engraving roll 1 is brought into contact with a printing subject and rotated, thereby performing printing.

The surface of the base layer 20 may be brought into contact with a gravure printing doctor blade (not shown), and as the surface of the base layer 20 is brought into contact with the doctor blade, the remaining printing material may be removed.

Since the base layer 20 comes continuously into contact with and produces friction with elements such as the printing subject or the doctor blade in the process of gravure printing, it may be easily abraded (or worn).

Thus, according to an embodiment of the present invention, the reinforcement coating layer 100 is coated on the base layer 20 formed on the surface of a roll frame 10 of the gravure printing engraving roll 1 to thereby allow for enhancement in durability and abrasion resistance of the printing pattern.

A lower portion in FIG. 1 is a partially enlarged view of a printing pattern, showing the structure of the reinforced coating layer 100.

The reinforcement coating layer 100 may include a first reinforcement layer 110, a first adhesive layer 130, a second adhesive layer 150, and a second reinforcement layer 170.

The first reinforcement layer 110 is formed in the reinforcement coating layer 100, and may be applied to the base layer 20 by a wet plating method. The second reinforcement layer 170 may be formed on the outermost portion of the reinforcement coating layer 100 in order to form an outer surface of the reinforcement coating layer.

The first adhesive layer 130 and the second adhesive layer 150 are formed between the first reinforcement layer 110 and the second reinforcement layer 170. The first adhesive layer 130 is formed to cover the surface of the first reinforcement layer 110 to provide adhesive strength to the surface of the first reinforcement layer 110. The second adhesive layer 150 is formed to cover a face of the second reinforcement layer 170, facing the first reinforcement layer 110 and provides an adhesive strength to the second reinforcement layer 110.

The roller frame 10 constitutes a roller of the gravure printing engraving roll 1 and supports the base layer 20, or the like, formed later. The roller frame 10 may be made of a material including iron (Fe); however, the present invention is not limited thereto.

The base layer 20 is formed on the roller frame 10 such that the roller frame has a desired printing pattern formed thereon. A printing pattern having a desired shape is formed on the base layer 20 through etching, or the like.

The base layer 20 is formed on the roller frame 10 in such a manner as to be plated. In order to secure an adhesive strength between the base layer 20 and the roller frame 10, a nickel-strike plating may be performed on the base layer 20, and then, the base layer 20 may be plated; however, the present invention is not limited thereto

In order to form a printing pattern having a desired shape, a resist is formed on the base layer 20 to be hardened and etched. Accordingly, the base layer 20 having a desired printing pattern formed thereon may be formed.

The base layer 20 may be made of a material allowing for the easy formation of a printing pattern having a desired shape through a process, such as etching, or the like. The base layer 20 may be formed as a plated layer made of a material including copper (Cu); however, the present invention is not limited thereto. In particular, in the case of a copper (Cu) plated layer, a precise printing pattern having a fine size may implemented therein through an etching process.

However, when the copper (Cu) plated layer is used as the base layer 20, the layer may be easily worn or damaged due to the low hardness thereof. Thus, in an embodiment of the present invention, the reinforce coating layer 100 may be formed on the base layer 20.

According to an embodiment of the present invention, a thickness “a” of the base layer 20 may range from 50 μm to 200 μm. If the thickness “a” of the base layer 20 is less than 50 μm, a printing pattern having a desired size could not be formed. In the other hand, if the thickness “a” of the base layer 20 exceeds 200 μm, the mechanical strength of the gravure printing engraving roll may be degrated due to the extremely large thickness of base layer 20.

According to an embodiment of the present invention, since the reinforcement coating layer 100 is formed on the base layer 20, the strength of the base layer 20 is enhanced. Thus, durability and abrasion resistance of the printing pattern formed in the base layer 20 may be excellent.

In particular, according to an embodiment of the present invention, the reinforcement coating layer 100 may include two reinforcement layers. The first reinforcement layer 110 adjacent to the base layer 20 may reinforce the strength of the base layer 20, and the second reinforcement layer 170 formed on an outer surface may secure durability and abrasion resistance of the printing pattern with respect to frictional contact with the outside.

Thus, according to an embodiment of the present invention, abrasion resistance of the printing pattern formed in the base layer 20 with respect to external frictional contact may be secured while increasing the strength of the base layer 20. Thus, since the strength of the printing pattern formed in the base layer 20 is increased and abrasion resistance thereof is secured, printing precision may be guaranteed in repetitive printing processes.

FIG. 2 is a partially enlarged view of the reinforcement coating layer 100 according to an embodiment of the present invention. The reinforcement coating layer 100 includes the first reinforcement layer 110, the first adhesive layer 130, the second adhesive layer 150, and the second reinforcement layer 170 sequentially stacked on the base layer 20.

The first reinforcement layer 110 may be formed on the base layer 20 by a wet plating method. When the base layer 20 is formed as a plated layer including copper (Cu), the base layer 20 may be easily oxidized. The first reinforcement layer 110 may be formed on the base layer 20 to increase the strength of the base layer 20 and to allow oxidation resistance thereof to be secured.

As a material of the first reinforcement layer 110, a material having a high oxidation resistance and durability while having a high affinity with copper (Cu) may be used. As a material of the first reinforcement layer 110, a material having durability while securing adhesive strength and adhesion to the base layer 20 may be used. The first reinforcement layer 110 may include one or more metal selected from the group consisting of tungsten (W), silicon (Si), titanium (Ti), zirconium (Zr), and chromium (Cr); however, the present invention is not limited thereto. In particular, the first reinforcement layer 110 may be formed with chromium (Cr) having a high affinity with copper (Cu) and high hardness.

The first reinforcement layer 110 may be formed by a wet plating method. In order to enhance the adhesive strength and adhesion to the base layer 20, the first reinforcement layer 110 may be formed on the base layer 20 by the wet plating method.

A thickness b₁ of the first reinforcement layer 110 may range from 0.1 μm to 10 μm. If the thickness b₁ of the first reinforcement layer 110 is less than 0.1 μm, the strength of the base layer 20 may not be secured. On the other hand, if the thickness b₁ of the first reinforcement layer 110 exceeds 10 μm, a crack may be generated on the surface of the first reinforcement layer 110 in terms of wet plating characteristics.

The second reinforcement layer 170 may be formed on the outermost portion of the reinforcement coating layer 100 so as to be exposed from an outer surface thereof. The second reinforcement layer 170 is formed to be in direct contact with a printing material or a doctor blade, and corresponds to a layer to which external physical stress is directly applied.

Thus, a material having superior durability and abrasion resistance than that of the first reinforcement layer 110 may be used for the second reinforcement layer 170. The second reinforcement layer 170 may be formed as a diamond like carbon (DLC) film; however, the present invention is not limited thereto. Also, in order to maximize a film strength of the second reinforcement layer 170 and resolve internal stress thereof, the second reinforcement layer 170 may be formed as a DLC film including silicon (Si).

The DLC film, formed by depositing carbon, has very similar properties to those of diamond. The DLC film is structurally different from a diamond crystal, but it has excellent oxidation resistance, high hardness, and smooth surface characteristics. Also, since a layer formed of the DLC film has a low frictional coefficient, abrasion resistance with respect to friction may be enhanced.

Thus, according to an embodiment of the present invention, the second reinforcement layer 170 may be formed as a DLC film. Thus, the surface of the printing pattern may have increased hardness and a smooth surface. Accordingly, the printing pattern may be prevented from being easily worn, even by a frictional contact with a printing material or a doctor blade.

In addition, according to an embodiment of the present invention, the second reinforcement layer 170 may be formed as a DLC film including silicon (Si). The DLC film including silicon (Si) has a structure in which a ratio between sp² bonds and sp³ bonds in carbon-hydrogen bonds within the crystal of film is 7:3, and thus the sp² bonds are relatively large. Accordingly, the structure contains hydrogen in a level of 5% to 30%. As the content of hydrogen in the crystal of the DLC film is increased, the crystal of the DLC film has reduced hardness, and as the content of hydrogen in the crystal of the DLC film is reduced, the crystal of the DLC film has increased hardness.

When a film is formed by depositing the DLC film including silicon (Si), Si is doped at the position of hydrogen included in the DLC film, such that the rate of hydrogen may be reduced. Thus, according to the reduced rate of hydrogen, the hardness of the DLC film may be further increased.

Besides, since silicon (Si) is doped to the carbon-hydrogen bonds, a Young's modulus of the second reinforcement layer 170 may be increased. Thus, the internal stress of the thin film is reduced to thereby allow for the formation of a stable layer having high hardness.

Thus, according to an embodiment of the present invention, the second reinforcement layer 170 may be formed as a DLC film including silicon (Si). According to an embodiment of the present invention, an atomic fraction (at %) of silicon (Si) with respect to the DLC in the second reinforcement layer 170 may range 2% to 15%. If the atomic fraction of silicon (Si) is less than 2%, the hardness of the film may be degraded. If the atomic fraction exceeds 15%, there is high possibly in which silicon (Si) exists alone, resulting in a generation of a portion thereof having a low hardness.

According to an embodiment of the present invention, a thickness b₄ of the second reinforcement layer 170 may range from 0.2 μm to 2 μm. If the thickness b₄ of the second reinforcement layer 170 is less than 0.2 μm, securing the durability and abrasion resistance of the gravure printing engraving roll may be difficult. If the thickness b₄ of the second reinforcement layer 170 exceeds 2 μm, the internal stress of the second reinforcement layer 170 may be increased to cause an exfoliation phenomenon of the second reinforcement layer 170. Also, if the thickness b₄ of the second reinforcement layer 170 exceeds 2 μm, a deposition time duration may be lengthened to thereby allow for increases in a unit cost.

According to an embodiment of the present invention, since the reinforcement coating layer 100 including the first and second reinforcement layers 110 and 170 may be formed on the base layer 20, the hardness of the printing pattern formed in the base layer 20 may be increased and abrasion resistance thereof may be secured.

According to an embodiment of the present invention, since the durability and abrasion resistance of the printing pattern are increased, even in the case of a printing material which has a large content of solid ingredients including ceramics or metals, it may be applied to the gravure printing engraving roll.

A printing material including ceramics or metals is highly abrasive. Thus, when the printing material is applied to gravure printing, printing precision may be degraded and the gravure printing engraving roll or the doctor blade needs to be changed frequently due to the easy wear properties of a printing pattern.

However, according to an embodiment of the present invention, since the reinforcement coating layer 100 is formed on the printing pattern, abrasion resistance of the gravure printing engraving roll may be improved. Thus, the burden of frequently changing the gravure printing engraving roll may be lessened.

Also, the second reinforcement layer 170 formed on the outermost portion of the reinforcement coating layer 100 is formed as a smooth, solid layer having a low frictional coefficient. Thus, even in the case of using a printing medium including a large amount of solid ingredients, the printing material may be easily detached from the printing pattern. Accordingly, the printing material may be easily transferred to a printing object and applied to print a thin pattern.

Thus, gravure printing may be applied to a component required to have thinned layers and a small size, such as a multilayer ceramic capacitor (MLCC). In particular, in order to print an internal electrode pattern of an MLCC, the gravure printing engraving roll according to an embodiment of the present invention may be employed. Thus, the thin internal electrode pattern of the MLCC may be printed while having a reduced thickness at a faster speed.

The first reinforcement layer 110 may be made of metal including chromium (Cr), and the second reinforcement layer 170 is formed as a DLC film, namely, made of a material based on carbon. Thus, since the first and second reinforcement layers 110 and 170 are respectively formed of materials having different properties, the first and second reinforcement layers 110 and 170 have a low affinity and thus may be easily separated from the base layer 20. Thus, in order to prevent the separation, an adhesive strength and adhesion between the first and second reinforcement layers 110 and 170 needs to be secured.

According to an embodiment of the present invention, the first adhesive layer 130 may be formed on the first reinforcement layer 110 so as to cover the surface thereof, and the second adhesive layer 150 may be formed so as to cover a face of the second reinforcement layer 170, the face facing the first reinforcement layer 110.

The first adhesive layer 130 may be made of metal having an excellent affinity with the first reinforcement layer 110, and may allow for increases in adhesive strength of the first reinforcement layer 110 to the second reinforcement layer 170.

Since the first reinforcement layer 110 is formed on the base layer 20 by a wet plating method, cracks may be generated in the surface thereof. Thus, the first adhesive layer 130 may be made of a material the same as or similar to that of the first reinforcement layer 110 such that the surface of the first reinforcement layer 110 having cracks formed therein may be uniform.

The first adhesive layer 130 may be formed of a metal layer including one or more selected from the group consisting of tungsten (W), titanium (Ti), chromium (Cr), zirconium (Zr), and molybdenum (Mo), however, the present invention is not limited thereto.

According to an embodiment of the present invention, the thickness b₂ of the first adhesive layer 130 may range from 0.1 μm to 5 μm. If the thickness b₂ of the first adhesive layer 130 is less than 0.1 μm, the film may be easily broken due to impacts or the like at the time of the rotating of the gravure printing engraving roll. If the thickness b₂ of the first adhesive layer 130 exceeds 5 μm, precision of the printing pattern formed in the base layer 20 may be damaged.

According to an embodiment of the present invention, the second adhesive layer 150 may be formed on the first adhesive layer 130. The second adhesive layer 150 may reinforce adhesive force between the second reinforcement layer 170 and the first adhesive layer 130, and accordingly, bonding strength between the first reinforcement layer 110 and the second reinforcement layer 170 may be further reinforced.

In forming a thin film such as a coating layer, the thin film is affected by a lattice constant of layers adjacent thereto. In forming the thin film through sputtering or chemical vapor deposition (CVD), atoms are precisely accumulated layer by layer to form the thin film.

Here, when the thin film is formed by using a material having a lattice constant different from those of the layers adjacent thereto, since intervals between atoms of the adjacent layers and the intervals between atoms forming the thin film are different, the thin film is not not stacked and the atoms forming the thin film may be tangled. Namely, interlayer adhesive strength may be degraded and the internal stress of the thin film may be increased.

The difference in lattice constants of the first reinforcement layer 110 and the second reinforcement layer 170 according to an embodiment of the present invention is shown in table 1 below.

TABLE 1

| | Coating layer | | | |
|---|---|---|---|---|
| | First | First | Second | Second |
| | reinforcement | adhesive | adhesive | reinforcement |
| | layer | layer | layer | layer |
| Configuration | Chromium | Chromium | Chromium | DLC layer |
| | wet plated | layer | nitride | |
| | layer | | layer | |
| Lattice | 3.0 | 2.9 | 3.1 | 3.5 |
| constant(A) | | | | |

According to an embodiment of the present invention, the lattice constant of the first reinforcement layer 110 is 3.0 and that of the second reinforcement layer 170 is 3.5. Since the difference between the lattice constant values of the first and second reinforcement layers 110 and 170 is 0.5, adhesive strength between the first and second reinforcement layers 110 and 170 may be degraded. Namely, if the second reinforcement layer 170 is formed immediately on the first adhesive layer 130, the second reinforcement layer 170 may not be easily attached to the first adhesive layer 130 and particles constituting the second reinforcement layer 170 may be tangled.

Thus, according to an embodiment of the present invention, the second adhesive layer 150 capable of complementing a difference in lattice constant values between the first adhesive layer 130 and the second reinforcement layer 170 may be formed. A lattice constant of the second adhesive layer 150 has a value between the lattice constant of the first adhesive layer 130 and that of the second reinforcement layer 170.

In other words, according to an embodiment of the present invention, the adhesive strength of the surface of the first reinforcement layer 110 may be enhanced. Since the first reinforcement layer 110 is a wet plated layer, fine cracks known as plating cracks may be formed on the first reinforcement layer 110. Thus, the first adhesive layer 130 may allow the surface of the first reinforcement layer 110 to be uniform, to thereby enable the surface of the first reinforcement layer 110 to have an increased bonding area with a different layer, whereby uniform adhesive strength over the first adhesive layer 130 may be secured and thus interlayer adhesive strength may be enhanced.

However, since the lattice constant value of the first adhesive layer 130 is smaller than that of the first reinforcement layer 110, the first adhesive layer 130 has a further increased difference in the lattice constant from that of the second reinforcement layer 170. Thus, the amount of adhesive strength between the first adhesive layer 130 and the second reinforcement layer 170 is reduced. Then, although uniform adhesive strength is enhanced by securing the uniformity of the surface of the first reinforcement layer 110, the amount of adhesive strength may be reduced. Namely, although uniform adhesive strength is obtained over the surface of the first reinforcement layer 110, the amount of adhesive strength itself may be reduced, whereby the first and second reinforcement layers 110 and 170 may be easily detached therefrom.

Thus, according to an embodiment of the present invention, the second adhesive layer 150 is formed between the first adhesive layer 130 and the second reinforcement layer 170, and serves to complement the difference in the lattice constant between the first adhesive layer 130 and the second reinforcement layer 170. Namely, the lattice constant value of the second adhesive layer 150 may have a median value between the lattice constant value of the first adhesive layer 130 and that of the second reinforcement layer 170.

According to an embodiment of the present invention, the second adhesive layer 150 may have a lattice constant value of 3.1, such that a difference in the lattice constant between the second adhesive layer 150 and the first adhesive layer 130 may be reduced to 0.2 and a difference in the lattice constant between the second adhesive layer 150 and the second reinforcement layer 170 may be reduced to 0.4.

Namely, when the first adhesive layer 130 and the second reinforcement layer 170 are directly bonded, a difference in lattice constant between is 0.6. However, the first adhesive layer 130 and the second reinforcement layer 170 are attached by the medium of the second adhesive layer 150 serving to reduce the difference in lattice constant with the first adhesive layer 130 to 0.2 and to reduce the difference in lattice constant with the second reinforcement layer 170 to 0.4, whereby the adhesive strength therebetween may be increased. As a result, the adhesive strength may be enhanced.

According to an embodiment of the present invention, the first adhesive layer 130 provides adhesive strength to the first reinforcement layer 110, while allowing the surface of the first reinforcement layer 11 to be uniform, thereby allowing for uniform interlayer adhesive strength. The second adhesive layer 150 may enable the amount of adhesive strength between the first adhesive layer 130 and the second reinforcement layer 170 to be increased. Accordingly, uniform, strong adhesive strength between the first reinforcement layer 130 and the second reinforcement layer 170 may be secured.

Also, the second adhesive layer 150 may allow internal stress of the reinforcement coating layer 100 to be distributed and reinforce mechanical strength of the reinforcement coating layer 100, as well as increasing adhesive strength. The second adhesive layer 150 may be formed as a metal nitride layer in order to increase affinity with the second reinforcement layer 170 and secure mechanical strength; however the present invention is not limited thereto. Also, in order to increase affinity with the first reinforcement layer 110, the second adhesive layer 150 may be configured as a metal nitride layer including one or more metal selected from the group consisting of tungsten (W), titanium (Ti), chromium (Cr), zirconium (Zr), and molybdenum (Mo); however, the present invention is not limited thereto.

A thickness b₃ of the second adhesive layer 150 may range from 0.1 μm to 1 μm. If the thickness b₃ of the second adhesive layer 150 is less than 0.1 μm, the second adhesive layer 150 may have an insufficient thickness, such that improvements in the adhesive strength between the first adhesive layer 130 and the second reinforcement layer 170 may be difficult. If the thickness b₃ of the second adhesive layer 150 exceeds 1 μm, an excessive nitride may be formed to hinder the second adhesive layer 150 and the second reinforcement layer 170 from being attached, thereby causing an exfoliation phenomenon.

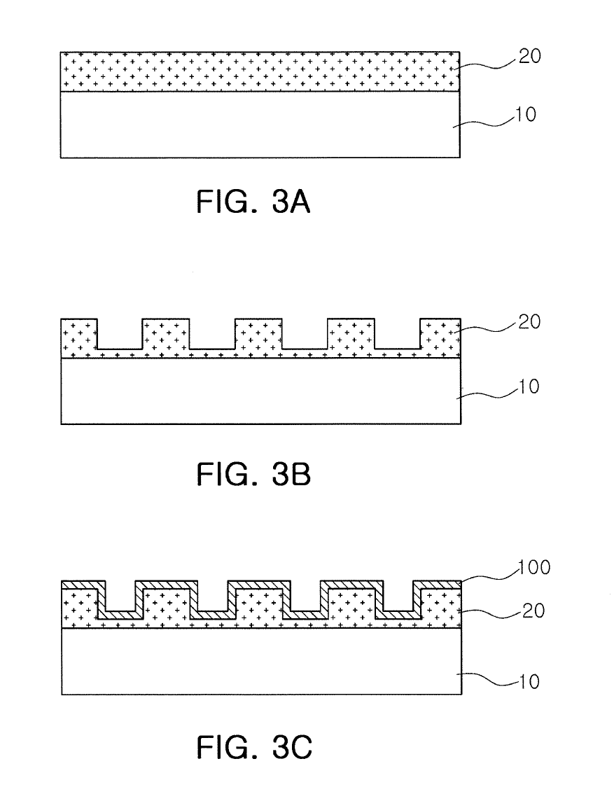

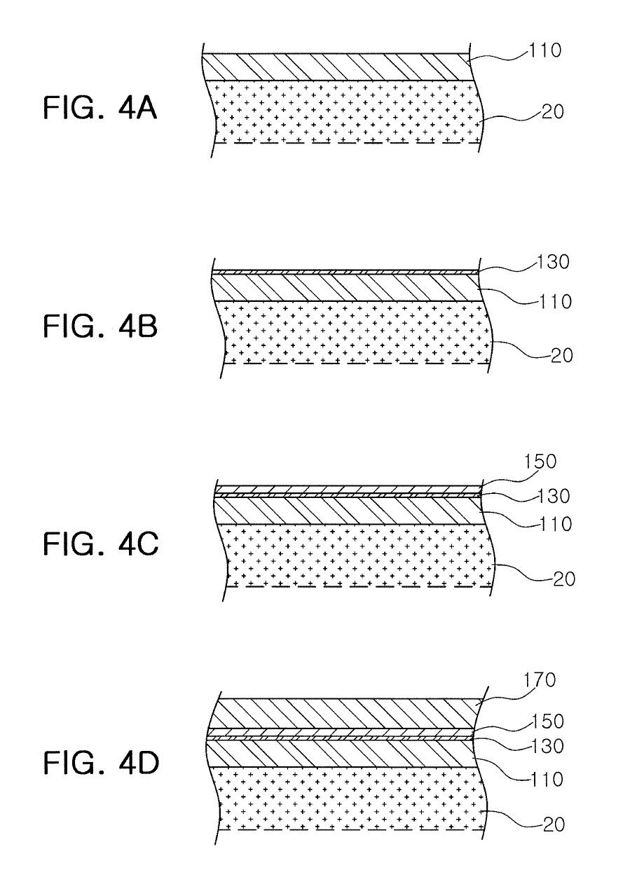

A method of manufacturing a gravure printing engraving roll according to an embodiment of the present invention will now be described with reference to FIGS. 3A through 3C and 4A through 4D.

FIGS. 3A through 3C show a process flow chart illustrating a process of forming a printing pattern on the base layer 20 of the gravure printing engraving roll according to an embodiment of the present invention.

Referring to FIG. 3A, the base layer 20 is formed on the roll frame 10 in order to form a printing pattern desired to be printed on the gravure printing engraving roll.

The roll frame 10, a frame constituting a roller, serves to continuously rotate a printing pattern to thereby transfer printing pattern to a printing object. The roll frame 10 may be made of a rigid material including iron (Fe); however, the present invention is not limited thereto.

The base layer 20 may be formed on the roll frame 10. The base layer 20 may be formed as a plated layer including copper (Cu). The roll frame 10 is immersed in a plating bath including an aqueous solution including copper sulfate and sulfuric acid and then has current applied thereto, such that the base layer 20 may be formed through an electro-plating method. Alternatively, the base layer 20 may be formed by an electroless plating method in which primary plating is performed with nickel strike plating and secondary plating is then performed with a copper sulfate solution.

Referring to FIG. 3B, a printing pattern may be formed on the base layer 20. A printing pattern having a desired shape may be formed on the base layer 20 by using laser, or a resist may be formed and etched to form a desired printing pattern; however, the present invention is not limited thereto.

Referring to FIG. 3C, the reinforcement coating layer 100 may be formed on the base layer 20 provided with a printing pattern having a desired shape. Thus, the printing pattern is coated with the reinforcement coating layer 100, such that the printing pattern may have high hardness, durability, and abrasion resistance.

The base layer 20 may be made of a material allowing for a printing pattern having a desired shape to be easily formed through a process such as etching, or the like. The base layer 20 may be made of a material including copper (Cu); however, the present invention is not limited thereto.

According to an embodiment of the present invention, a copper (Cu) plated layer having a low hardness may be used as the base layer 20, and in this case, a pattern having a fine size may be implemented through an etching process.

According to an embodiment of the present invention, the thickness “a” of the base layer 20 may range from 50 μm to 200 μm. If the thickness “a” of the base layer 20 is less than 50 μm, the base layer 20 may have an extremely thin thickness, such that a printing pattern having a desired size and shape may not be formed. If the thickness “a” of the base layer 20 exceeds 200 μm, the thickness of the base layer 20 having a low hardness is extremely thick, such that mechanical strength of the gravure printing engraving roll may be degraded.

According to an embodiment of the present invention, the base layer 20 in itself may be made of a material having a low hardness; however, the reinforcement coating layer 100 is formed on the base layer 20 provided with a printing pattern, such that the durability and abrasion resistance of the printing pattern may be enhanced.

FIGS. 4A through 4D show a process flow chart illustrating a method of manufacturing the reinforcement coating layer 100.

Referring to FIG. 4A, first, the first reinforcement layer 110 is formed on the base layer 20 provided with the printing pattern.

According to an embodiment of the present invention, the first reinforcement layer 110 may be formed by a wet plating method, and in this case, the wet plating of the first reinforcement layer 110 may be performed by an electro-plating method using a mixed aqueous solution of chromic acid anhydride and sulfuric acid as a plating solution. However, the present invention is not limited thereto. Since the first reinforcement layer 110 is formed by the wet plating method, it may obtain excellent adhesive strength without a separate adhesive layer.

According to an embodiment of the present invention, after the first reinforcement layer 110 is formed, surface polishing may be performed on the surface of the first reinforcement layer 110 so as to improve smoothness thereof. Polishing and cleansing may be performed by argon (Ar) ions; however, the present invention is not limited thereto. Through such a polishing and cleansing process, contaminants potentially formed on the surface of the base layer 20 may be eliminated, and molecules constituting the base layer 20 and the first reinforcement layer 110 may be excited to thereby facilitate the deposition of another layer thereon, to be performed thereafter.

The first reinforcement layer 110 is formed by a wet plating method so as to cover the base layer 20. The first reinforcement layer 110 may allow for the reinforced strength of the base layer 20. Also, the first reinforcement layer 110 may be made of a metal having excellent oxidation resistance and may protect the base layer 20 made of a metal having high oxidation, such as copper (Cu).

According to an embodiment of the present invention, the first reinforcement layer 110 may be made of a material having high oxidation resistance and durability while having a high affinity with copper (Cu). A material capable of securing durability while securing an adhesive strength and adhesion with respect to the base layer 20 may be used for the first reinforcement layer 110. The first reinforcement layer 110 may be made of a material including one or more metal selected from the group consisting of tungsten (W), silicon (Si), titanium (Ti), zirconium (Zr), and chromium (Cr); however, the present invention is not limited thereto. In particular, the first reinforcement layer 110 may be formed as a chromium (Cr) plated layer having a high affinity with copper (Cu).

The thickness of the first reinforcement layer 110 may range from 0.1 μm to 10 μm. If the thickness of the first reinforcement layer 110 is less than 0.1 μm, the thickness of the first reinforcement layer 110 is not sufficient to secure the strength of the base layer 20. If the thickness of the first reinforcement layer 110 exceeds 10 μm, a plating crack may be induced to the surface of the reinforcement layer 110 in terms of the characteristics of the wet plated layer.

Referring to FIG. 4B, the first adhesive layer 130 may be formed on the first reinforcement layer 110.

The first adhesive layer 130 may allow the surface of the first reinforcement layer 110 to be uniform. The first adhesive layer 130 may allow the surface of the first reinforcement layer 110, which is uneven due to cracks formed through the wet plating, to be uniform. Accordingly, a uniform adhesive strength may be formed between the second reinforcement layer 170 and the first reinforcement layer 110. The first adhesive layer 130 may serve to improve the adhesive strength between the first reinforcement layer 110 and the second reinforcement layer 170.

The first adhesive layer 130 may be formed by various known thin film formation methods such as a sputtering method, a vacuum deposition method, an ion plating method, a molecular beam epitaxy (MBE) method, a laser ablation method, an ion assist deposition method, a plasma chemical deposition method, or the like.

The first adhesive layer 130 may be made of a metal having an excellent affinity with the first reinforcement layer 110, or a material the same as or similar to that of the first reinforcement layer 110 may be used. The first adhesive layer 130 may be formed as a metal layer made of one or more selected from the group consisting of tungsten (W), titanium (Ti), chromium (Cr), zirconium (Zr), and molybdenum (Mo); however, the present invention is not limited thereto. According to an embodiment of the present invention, when the base layer 20 is formed as a chromium (Cr)-plated layer, a chromium (Cr) sputtering layer may be used as the first adhesive layer 130 in order to enhance affinity with the base layer 20.

According to an embodiment of the present invention, the thickness of the first adhesive layer 130 may range from 0.1 μm to 5 μm. If the thickness of the first adhesive layer 130 is less than 0.1 μm, the surface of the first reinforcement layer 110 may not be sufficiently uniform and the film may be easily damaged due to impacts, or the like, at the time of using the gravure printing engraving roll. If the thickness of the first adhesive layer 130 exceeds 5 μm, the precision of the printing pattern formed on the base layer 20 may be damaged.

Referring to FIG. 4C, the second adhesive layer 150 may be formed on the first adhesive layer 130. The second adhesive layer 150 may reinforce the adhesive strength between the second reinforcement layer 170 and the first adhesive layer 130.

The first adhesive layer 130 may allow for the smooth surface of the first reinforcement layer 110 to secure uniform adhesive strength; however, the intensity of the adhesive strength is degraded due to the difference in the lattice constant between the first adhesive layer 130 and the second reinforcement layer 170 to thereby cause the adhesive strength to be degraded. The first reinforcement layer 110 and the first adhesive layer 130 may be made of materials having a different structure from that of the second reinforcement layer 170, such that the adhesive strength therebetween may be lessened to cause difficulties in securing sufficient adhesive strength.

Thus, according to an embodiment of the present invention, the second adhesive layer 150 may be made of a material having a lattice constant present between the lattice constant of the first adhesive layer 130 and that of the second reinforcement layer 170. Accordingly, the second adhesive layer 150 may be formed between the first adhesive layer 130 and the second reinforcement layer 170 to complement the difference in the lattice constants. Accordingly, the adhesive strength between the first adhesive layer 130 and the second reinforcement layer 170 may be enhanced. As a result, uniform amount of adhesive strength may be evenly formed on the bond surface between the first reinforcement layer 110 and the second reinforcement layer 170 due to the first adhesive layer 130, and the amount of adhesive strength may be improved by the second adhesive layer 150.

The second adhesive layer 150 may be formed by various known thin film formation methods such as a sputtering method, a vacuum deposition method, an ion plating method, a molecular beam epitaxy (MBE) method, a laser ablation method, an ion assist deposition method, a plasma chemical deposition method, or the like.

When a metal nitride layer is used as the second adhesive layer 150, the adhesive strength may be improved, the internal stress of the reinforcement coating layer 100 may be dispersed, and mechanical strength may be reinforced. This is because the metal nitride layer has high mechanical strength, as compared to a general metal carbide layer.

According to an embodiment of the present invention, the second adhesive layer 150 may be formed as a metal nitride layer in order to enhance affinity with the second reinforcement layer 170 and secure sufficient mechanical strength. Also, the second adhesive layer 150 may be formed as a metal nitride layer including one or more metal selected from the group consisting of tungsten (W), titanium (Ti), chromium (Cr), zirconium (Zr), and molybdenum (Mo) in order to increase affinity with the first adhesive layer 130 and the first reinforcement layer 110; however, the present invention is not limited thereto.

The thickness b₃ of the second adhesive layer 150 may range from 0.1 μm to 1 μm. If the thickness b₃ of the second adhesive layer 150 is less than 0.1 μm, the thickness of second adhesive layer 150 may be insufficient, causing difficulties in securing the adhesive strength between the first adhesive layer 130 and the second reinforcement layer 170. If the thickness b₃ of the second adhesive layer 150 exceeds 1 μm, excessive nitrides may be formed to hinder the second adhesive layer 150 and the second reinforcement layer 170 from being attached, causing an exfoliation phenomenon.

Referring to FIG. 4D, the second reinforcement layer 170 may be formed on the second adhesive layer 150 according to an embodiment of the present invention.

The second reinforcement layer 170 may be formed on the outermost portion of the reinforcement coating layer 100 so as to be exposed to the outer surface of the reinforcement coating layer 100. The second reinforcement layer 170 may be formed to be in direct contact with a printing material or a doctor blade, and may directly receive external physical stress.

Thus, a material having a higher hardness than that of the first reinforcement layer 110 may be used for the second reinforcement layer 170, or a material having superior abrasion resistance and durability to those of the first reinforcement layer 110 may be used for the second reinforcement layer 170. The second reinforcement layer 170 may be formed as a diamond like carbon (DLC) film; however, the present invention is not limited thereto. Also, in order to maximize a film strength of the second reinforcement layer 170 and resolve internal stress, the second reinforcement layer 170 may be formed as a DLC film including silicon (Si).

The DLC film formed through the deposition of carbon, has very similar properties to those of diamond. The DLC film is structurally different from a diamond crystal, but it has excellent oxidation resistance and chemical resistance, high hardness, and smooth surface characteristics. That is, a layer formed as the DLC film has a low frictional coefficient, the layer may have a sufficient abrasion resistance and durability against continuous friction.

Also, when the second reinforcement layer 170 is formed as the DLC film including silicon (Si), the strength of the second reinforcement layer 170 may be further reinforced. Hardness of the DLC film may be reduced as the content of hydrogen in crystal thereof is increased; however, in the case of the DLC film including silicon (Si), silicon (Si) is doped at the position of hydrogen, leading to a decrease in the content of hydrogen. Thus, the ratio of hydrogen is reduced and the hardness of the DLC film may be further increased.

Furthermore, as silicon (Si) is doped to the carbon-hydrogen bonds, Young's modulus of the second reinforcement layer 170 may be increased. Thus, the internal stress of the reinforcement coating layer 100 is reduced, thereby allowing for the formation of a stable layer having a high hardness.

Since the DLC film including silicon (Si) has a low frictional coefficient, bonding or fusion to a printing object may be reduced at the time of using the gravure printing engraving roll, leading to a reduction in a defective rate during the manufacturing of products.

According to an embodiment of the present invention, the second reinforcement layer 170 may be formed by any one of a sputtering method, a vacuum deposition method, an ion plating method, a molecular beam epitaxy (MBE) method, a laser ablation method, an ion assist deposition method, a plasma chemical deposition method, and an ion beam deposition method.

According to an embodiment of the present invention, in order to form the second reinforcement layer 170 by the ion beam deposition method, the gravure printing engraving roll including the first reinforcement layer 110, the first adhesive layer 130, and the second adhesive layer 150 formed thereon is installed in a reaction chamber. The interior of the reaction chamber is maintained in a vacuum state, and gas as a deposition source for supplying carbon may be supplied to an ion beam deposition device.

According to an embodiment of the present invention, hydrocarbon (CₓH_{y})-based gas may be used as a deposition source, and CH₄, C₂H₂, C₆H₆, or C₄H₁₀ may be used; however, the present invention is not limited thereto.

Also, in order to form the DLC film including silicon (Si), the hydrocarbon-based gas and silane gas (SiH₄) may be put together as a deposition source, in the device; however, the present invention is not limited thereto.

After deposition sources are supplied to the reaction chamber, power is applied to an ion gun. As power is applied to the ion gun, deposition sources are excited into a plasma state so as to be deposited as the second reinforcement layer 170 on the surface of the second adhesive layer 150. The second reinforcement layer 170 may be uniformly deposited on a printing pattern of a fine size through the ion beam deposition. Energy of ions coated on the second adhesive layer 150 is controlled, and the frequency and voltage of power supplied to discharge accumulated electric charges may be regulated. A time duration in which power is applied is regulated, whereby the thickness of the second adhesive layer 150 may be adjusted.

According to an embodiment of the present invention, the thickness of the second reinforcement layer 170 may range from 0.2 μm to 2 μm. If the thickness of the second reinforcement layer 170 is less than 0.2 μm, the abrasion resistance and durability of the gravure printing engraving roll may be significantly degraded. If the thickness of the second reinforcement layer 170 exceeds 2 μm, the exfoliation phenomenon of the second reinforcement layer 170 may be caused due to high internal stress of the coating material. Also, a production unit cost may be increased due to an increase in a coating process time.

According to an embodiment of the present invention, since the reinforcement coating layer 100 formed of the first reinforcement layer 110 and the second reinforcement layer 170 may be formed on a printing pattern, the gravure printing engraving roll having a printing pattern with excellent durability and abrasion resistance may be implemented.

Thus, the gravure printing engraving roll according to an embodiment of the present invention may be applicable to electronic components using a ceramic or metal powder as a printing material.

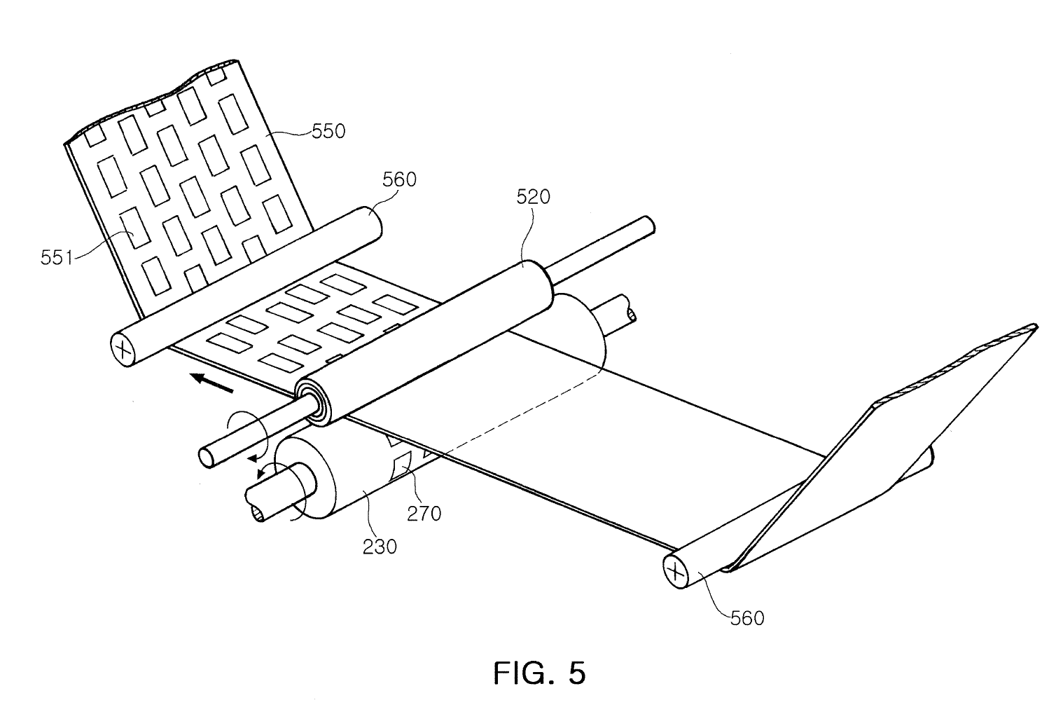

FIG. 5 is a schematic view showing printing of internal electrodes of a multilayer ceramic capacitor by using the gravure printing engraving roll according to an embodiment of the present invention.

In order to print internal electrodes of a multilayer ceramic capacitor according to an embodiment of the present invention, a plurality of dielectric layers may be prepared. According to an embodiment of the present invention, the plurality of dielectric layers may be provided in the form of a carrier film 550. After the internal electrodes 551 are printed, they may be cut to have a chip size.

A gravure printing engraving roll 230 having the reinforcement coating layer 100 formed thereon is immersed in paste for internal electrodes, whereby an internal electrode pattern may be printed on the plurality of dielectric layers.

The gravure printing device for a multilayer ceramic capacitor includes a press roll 520 and a printing engraving roll 230. Also, the gravure printing device for a multilayer ceramic capacitor further includes two guide rolls 560 guiding the carrier film 550. As the press roll 520 and the printing engraving roll 230 are rotated together with the carrier film 550 interposed therebetween, a printing material (or a printing medium) filled in the printing pattern 270 of the printing engraving roll 230 may be transferred to the carrier film 550, thus printing the internal electrode pattern 551.

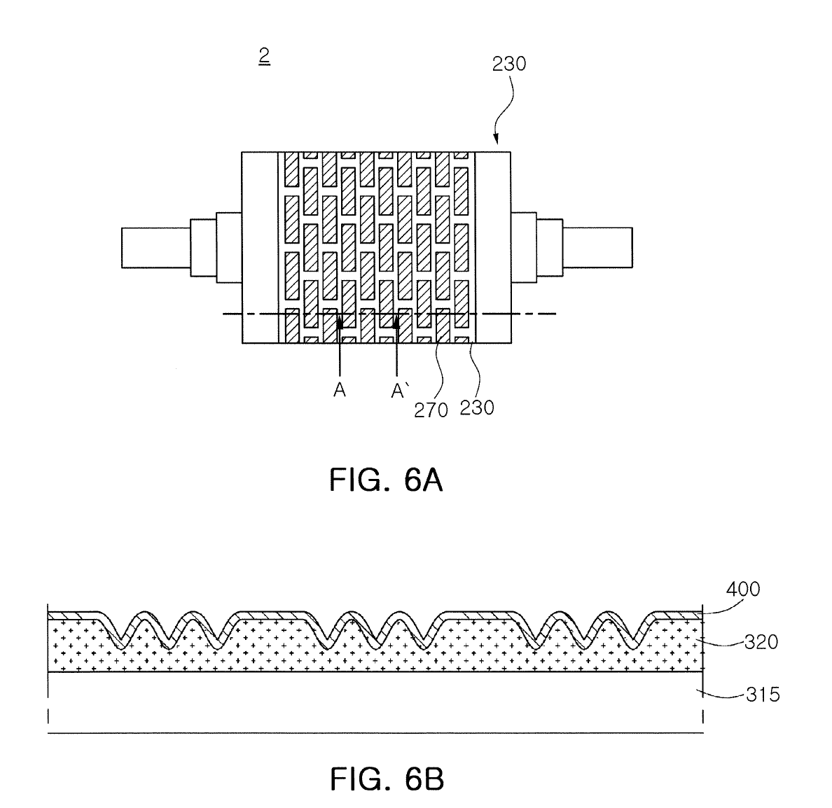

Referring to FIG. 6A, the gravure printing engraving roll 230 for a multilayer ceramic capacitor according to an embodiment of the present invention includes a plurality of printing patterns 270.

Referring to FIG. 6B showing a sectional view taken along line A-A′ of the printing pattern 270, a base layer 320 is formed on a roll frame 315, and printing patterns for printing the internal electrode patterns are formed on the base layer 320. According to an embodiment of the present invention, a reinforcement coating layer 400 is formed on the base layer 320 provided with the printing patterns formed thereon.

Thus, when a ceramic or metal is used as the gravure printing medium, the content of solid ingredients of the printing medium is high, such that friction applied to the printing patterns may be increased. Thus, the printing patterns are easily abraded, and the gravure printing engraving roll or a doctor blade needs to be frequently changed.

However, according to an embodiment of the present invention, even when the internal electrode patterns including a ceramic or metal are printed, the reinforcement coating layer 400 may be formed. In particular, the second reinforcement layer formed in the outermost portion of the reinforcement coating layer 400 may have a low frictional coefficient and a smooth surface.

Thus, printing patterns that are not easily abraded may be formed, and the burden of frequently changing the gravure printing engraving roll or the doctor blade may be lessened. Also, a phenomenon in which the printing material is attached to the printing patterns may be reduced, so that internal electrode patterns having a small thickness may be printed. Besides, since the printing patterns may not be easily worn or damaged, when fine patterns such as the internal electrode patterns are printed, printing reliability may be enhanced.

Hereinafter, embodiments of the present invention will be described in more detail, but these embodiments are merely illustrative, and should not be limitedly construed.

### Example 1

According to an example of the present invention, a copper (Cu) plated layer was formed as a base layer, and a chromium (Cr) wet plated layer was formed as a first reinforcement layer. A chromium (Cr) sputtering layer was formed as a first adhesive layer on the chromium (Cr) wet plated layer, and a second adhesive layer was formed as a chromium nitride layer on the first adhesive layer through sputtering.

In order to form a second reinforcement layer on the surface of the second adhesive layer, a gravure printing engraving roll was cleansed by using argon ions (Ar+) in order to remove an oxide film or contaminants formed on the surface. Cleaning was performed for 10 to 1000 minutes by applying a voltage of 700 V to 3000 V to an ion gun.

C₂H₂ was supplied to an ion gun deposition device so as to supply hydrocarbon-based gas thereto. A voltage of 700 V to 3000 V was applied to the ion gun to supply C₂H₂ through a gas supply unit. Accordingly, power was supplied to the ion gun to generate carbon plasma through an ion beam deposition.

A DLC thin film was formed while applying the frequency of 1 kHz to 350 kHz and −60 V to −600 V in order to control energy of coated ions and discharge accumulated electric charges. In order to implement various thicknesses, a processing time was regulated. A second reinforcement layer having a thickness ranging from 0.2 μm to 2 μm and formed as a DLC thin film was formed on the surface of the second adhesive layer by applying voltage during 10 to 300 minutes.

### Example 2

In order to confirm adhesive strength and durability of the gravure printing engraving roll, adhesive strength and durability of a gravure printing engraving roll without a wet plated layer, a first reinforcement layer, according to a comparative example and those of the gravure printing engraving roll according to an example of the present invention were compared.

In the comparative example, a copper (Cu) plated layer was formed as a base layer, a chromium (Cr) sputtering layer was directly formed as a coated layer on the copper (Cu) plated layer, and a chromium nitride layer was formed on the chromium (Cr) sputtering layer through sputtering to form an adhesive layer, and a DLC layer was formed.

According to an example of the present invention, in the same manner as that of example 1, a base layer was formed as a copper (Cu) plated layer. A chromium (Cr) wet plated layer was formed as a first reinforcement layer on the base layer as a reinforcement coating layer, and a chromium (Cr) sputtering layer was formed as a first adhesive layer on the chromium (Cr) wet plated layer. A second adhesive layer was formed as a chromium nitride layer on the first adhesive layer through sputtering. And then, a DLC layer was formed on the second adhesive layer to prepare a second reinforcement layer.

In order to compare the adhesive strength and abrasion of the reinforcement coating layers according to the comparative example of the present invention and an example of the present invention, the surface of the reinforcement coating layer according to the comparative example and the surface of the reinforcement coating layer according to the example of the present invention were scratched with an iron ball by 10 mm at the speed of 0.2 mm/min while continuously increasing the magnitude of applied force from 0.1 to 10N. Then, a point in time at which the coating layer was exfoliated from the surface was checked.

According to the comparative example, the coating layer became exfoliated and damaged from 4N. Meanwhile, in the case of the formation of the reinforcement coating layer according to the example of the present invention, the coating layer became exfoliated and damaged from 6N.

According to the example of the present invention, the first reinforcement layer may be formed by the wet plating method, the first adhesive layer allowing the surface of the first reinforcement layer to be uniform while providing adhesive strength to the surface of the first reinforcement layer, and attaching the first and second reinforcement layers may be formed, the second adhesive layer for attaching the first adhesive layer and the second reinforcement layer may be formed, and then the second reinforcement layer may be formed. Thus, the surface strength and durability of the gravure printing engraving roll may be remarkably enhanced.

As set forth above, according to the embodiments of the present invention, a gravure printing engraving roll provided with printing patterns having high hardness can be provided. Thus, a gravure printing engraving roll having excellent abrasion resistance and durability can be provided.

According to an embodiment of the present invention, since the durability and abrasion resistance of the gravure printing engraving roll can be enhanced, the gravure printing engraving roll can also be used for manufacturing a multilayer ceramic capacitor, in a manufacturing process of which, a large amount of friction may be applied thereto.

According to an embodiment of the present invention, since the abrasion resistance of the gravure printing engraving roll could be enhanced, the burden of frequently changing the gravure printing engraving roll in the printing process can be lessened and printing reliability can be enhanced.

While the present invention has been shown and described in connection with the embodiments, it will be apparent to those skilled in the art that modifications and variations can be made without departing from the spirit and scope of the invention as defined by the appended claims.

What is claimed is:

1. A gravure printing engraving roll comprising:
a base layer provided with gravure printing patterns; and
a reinforcement coating layer applied to the base layer in order to reinforce strength of the base layer,
the reinforcement coating layer including a first reinforcement layer formed on the base layer by a wet plating method, a second reinforcement layer forming an outer surface of the reinforcement coating layer, a first adhesive layer disposed between the first and second reinforcement layers and providing adhesive strength to a surface of the first reinforcement layer, and a second adhesive layer providing adhesive strength between the first adhesive layer and the second reinforcement layer.

2. The gravure printing engraving roll of claim 1, wherein the first adhesive layer allows the surface of the first reinforcement layer to be uniform.

3. The gravure printing engraving roll of claim 1, wherein a lattice constant of the second adhesive layer has a value between a lattice constant of the first adhesive layer and a lattice constant of the second reinforcement layer.

4. The gravure printing engraving roll of claim 1, wherein the base layer is a plated layer including copper (Cu).

5. The gravure printing engraving roll of claim 1, wherein the first reinforcement layer is a wet plated layer including chromium (Cr).

6. The gravure printing engraving roll of claim 1, wherein the second reinforcement layer is formed as a diamond like carbon (DLC) film.

7. The gravure printing engraving roll of claim 1, wherein the second reinforcement layer is formed as a DLC film including silicon (Si).

8. The gravure printing engraving roll of claim 7, wherein an atomic fraction of silicon (Si) with respect to DLC of the second reinforcement layer is 2% to 15%.

9. The gravure printing engraving roll of claim 1, wherein the first adhesive layer is a metal layer including one or more selected from a group consisting of tungsten (W), titanium (Ti), chromium (Cr), zirconium (Zr), and molybdenum (Mo).

10. The gravure printing engraving roll of claim 1, wherein the second adhesive layer is a metal nitride layer including one or more metal selected from a group consisting of tungsten (W), titanium (Ti), chromium (Cr), zirconium (Zr), and molybdenum (Mo).

11. The gravure printing engraving roll of claim 1, wherein a thickness of the first reinforcement layer ranges from 0.1 μm to 10 μm.

12. The gravure printing engraving roll of claim 1, wherein a thickness of the second reinforcement layer ranges from 0.2 μm to 2 μm.

13. The gravure printing engraving roll of claim 1, wherein a thickness of the first adhesive layer ranges from 0.1 μm to 5 μm.

14. The gravure printing engraving roll of claim 1, wherein a thickness of the second adhesive layer ranges from 0.1 μm to 1 μm.

15. The gravure printing engraving roll of claim 1, wherein the printing patterns are internal electrode printing patterns for a multilayer ceramic capacitor (MLCC).

16. A method of manufacturing a gravure printing engraving roll, the method comprising:
forming patterns for gravure printing on a base layer;
forming a first reinforcement layer on the base layer by a wet plating method;
forming a first adhesive layer providing adhesive strength to a surface of the first reinforcement layer on the first reinforcement layer;
forming a second adhesive layer on the first adhesive layer so as to provide adhesive strength with the second reinforcement layer; and
forming a second reinforcement layer on the second adhesive layer.

17. The method of claim 16, wherein the first adhesive layer allows the surface of the first reinforcement layer to be uniform.

18. The method of claim 16, wherein a lattice constant of the second adhesive layer has a value between a lattice constant of the first adhesive layer and a lattice constant of the second reinforcement layer.

19. The method of claim 16, wherein the base layer is formed through a copper (Cu) plating process.

20. The method of claim 16, wherein the first reinforcement layer is formed through a chromium (Cr) wet plating process.

21. The method of claim 16, wherein the second reinforcement layer is formed through a diamond like carbon (DLC) film deposition process.

22. The method of claim 16, wherein a thickness of the first reinforcement layer ranges from 0.1 μm to 10 μm.

23. The method of claim 16, wherein a thickness of the second reinforcement layer ranges from 0.2 μm to 2 μm.

24. The method of claim 16, wherein a thickness of the first adhesive layer ranges from 0.1 μm to 5 μm.

25. The method of claim 16, wherein a thickness of the second adhesive layer ranges from 0.1 μm to 1 μm.

26. A method of manufacturing a multilayer ceramic capacitor, the method comprising:
preparing a plurality of dielectric layers; and
printing internal electrode patterns on the plurality of dielectric layers by immersing the gravure printing engraving roll of claim 1 in paste for internal electrodes.
